(19) United States
(12) Patent Application Publication
(10) Pub. No.: US 2025/0340249 A1
(43) Pub. Date: Nov. 6, 2025

(54) STRUCTURAL MEMBER

(71) Applicant: NIPPON STEEL CORPORATION, Tokyo (JP)

(72) Inventor: Kazuo UEMATSU, Chiyoda-ku, Tokyo (JP)

(21) Appl. No.: 18/696,428

(22) PCT Filed: Oct. 15, 2021
(86) PCT No.: PCT/JP2021/038164

§ 371 Date: Nov. 15, 2024

(51) Int. Cl. B62D 29/00; B62D 21/15

(52) U.S. Cl. CPC B62D 29/007; B62D 21/15

(57) ABSTRACT

This structural member is a structural member including a plurality of high strength steel pipes, in which the high strength steel pipe has a quenched portion in a pipe center portion and a non-quenched portion extending over a whole circumference of at least one pipe end portion, in the quenched portion, an area ratio of a martensite is 90% or more, in the non-quenched portion, an area ratio of a ferrite is 30% or more and 100% or less, an area ratio of a pearlite is 0% or more and 70% or less, and a total area ratio of a martensite and a bainite is 0% or more and 10% or less, and the non-quenched portion has a welded portion that is welded to another member.

### TECHNICAL FIELD OF THE INVENTION

The present invention relates to a structural member.

### RELATED ART

Structural members of vehicles are required to have high load-bearing performance and excellent impact energy absorption properties in order to enhance collision safety performance.

As a technique for the purpose of high load-bearing performance or excellent impact energy absorption properties, for example, Patent Document 1 discloses a structural member for a vehicle body, including: a main body made of steel having a hollow closed cross section, in which the main body includes, in an axial direction, in at least a portion, a quenched portion which is quenched, a base metal hardness portion having the same hardness as a base metal hardness, and a transition portion which is provided between the quenched portion and the base metal hardness portion in the axial direction and is generated to change in strength from a strength of the base metal hardness portion to a strength of the quenched portion, and in a case where a cross-sectional area of the main body is denoted by A and a second moment of area of the main body is denoted by I, a length L of the transition portion in the axial direction satisfies a predetermined relationship.

In addition, Patent Document 2 discloses a member joining structure in a vehicle body, including: a first member made of steel including a quenched portion that has a closed hollow cross section without an outwardly-extending flange, extends in one direction, and has a tensile strength of 1,470 MPa or more in the one direction, a base metal portion having a tensile strength of less than 700 MPa, and a transition portion that gradually changes in tensile strength between the quenched portion and the base metal portion from the tensile strength of the quenched portion to the tensile strength of the base metal portion; and a second member made of steel that overlaps with a portion of an outer surface of the first member at an overlapping portion, in which the first member and the second member are welded to each other at the overlapping portion, the overlapping portion is present over a range from the quenched portion of the first member to the base metal portion through the transition portion, and a welded portion generated by the welding is present in the transition portion or the base metal portion of the first member.

### PRIOR ART DOCUMENT

### Patent Document

[Patent Document 1] PCT International Publication No. WO2015/198867
[Patent Document 2] PCT International Publication No. WO2015/182549

### DISCLOSURE OF THE INVENTION

### Problems to be Solved by the Invention

High load-bearing performance and excellent impact energy absorption properties are both required for large vehicles such as buses. Structural members of buses are larger than that of passenger cars. For example, some main pillars of buses have a length of more than 3,000 mm. It is impossible to manufacture such a long structural member in one piece with existing facilities, and, in order to manufacture long structural members, significant investment is required for constructing new manufacturing facilities or modifying existing facilities. Therefore, it is conceivable to manufacture a long structural member by connecting materials such as quenched steel pipes used for structural members, which are manufactured using existing facilities. However, when the quenched steel pipes are welded to each other, there is a concern that a vicinity of a welded portion of the quenched steel pipe is softened by heat generated during the welding (heat input softening) and a strength of the structural member is reduced.

In Patent Document 1, the transition portion that changes in strength is identified by measuring a Vickers hardness at different measurement positions. In actual manufacturing, it is difficult to identify the transition portion by the above method, and there is margin for improvement in order to realize high load-bearing performance and excellent impact energy absorption properties by the method described in Patent Document 1. In Patent Document 2, a portion where the tensile strength changes is regarded as the transition portion. However, it is difficult to identify the transition portion by measuring the tensile strength of each portion of the steel pipe, and there is margin for improvement in order to realize high load-bearing performance and excellent impact energy absorption properties by the method described in Patent Document 2.

The present invention has been made in view of the above problems, and an object of the present invention is to provide a structural member having high load-bearing performance and excellent impact energy absorption properties even in a case where a plurality of materials are connected by welding.

### Means for Solving the Problem

The present inventors obtained knowledge that since heat input softening described above occurs in portions that have been subjected to treatments such as quenching and have a structure primarily containing martensite and/or bainite, the heat input softening is prevented by using high strength steel pipes having low strength at end portions of the steel pipes as a material of a structural member and welding the high strength steel pipes to each other at the end portions having low strength.

The gist of the present invention completed based on the above knowledge is as follows.

[1] A structural member according to an aspect of the present invention is a structural member including: a plurality of high strength steel pipes, in which the high strength steel pipe has a quenched portion in a pipe center portion and a non-quenched portion extending over a whole circumference of at least one pipe end portion, in the quenched portion, an area ratio of a martensite is 90% or more, in the non-quenched portion, an area ratio of a ferrite is 30% or more and 100% or less, an area ratio of a pearlite is 0% or more and 70% or less, and a total area ratio of a martensite and a bainite is 0% or more and 10% or less, and the non-quenched portion has a welded portion that is welded to another member.

[2] The structural member according to [1] may further include: as the other member, a joint part that is a hollow tubular member and has a center portion having a diameter larger than both end portions, and connection portions that connect both the end portions and the center portion, in which an end surface of the high strength steel pipe disposed in the non-quenched portion and the connection portion in the joint part are welded to each other, and an outer circumferential surface of the high strength steel pipe and an outer circumferential surface of the center portion are substantially coincident with each other.

[3] In the structural member according to [2], the joint part may be tubular.

[4] The structural member according to [1] may further include: as the other member, a joint part that is a hollow tubular member configured in a linear shape and has substantially the same diameter along an axial direction, in which end portions of the joint part in the axial direction are respectively inserted into the high strength steel pipes adjacent to each other, and respective end portions of the high strength steel pipes adjacent to each other are separated from each other and are welded to the joint part at different positions of the joint part in the axial direction.

[5] In the structural member according to any one of [2] to [4], the joint part may be constituted by two or more parts, and each of the two or more parts may include a portion included in an end surface of the joint part.

[6] In the structural member according to any one of [2] to [5], a strength of the joint part may be 590 MPa or less.

[7] In the structural member according to [1], an end surface of the high strength steel pipe disposed in the non-quenched portion and an end surface of the high strength steel pipe disposed in the non-quenched portion, which is the other member, may be butt-welded to each other such that outer circumferential surfaces of the high strength steel pipes are substantially coincident with each other.

[8] In the structural member according to [1], at least one high strength steel pipe among the plurality of high strength steel pipes may have a reduced diameter portion which is smaller in diameter than the pipe center portion in a predetermined region from an end surface of the high strength steel pipe toward a center in the axial direction, the reduced diameter portion may be inserted into the other high strength steel pipe, which is the other member, an outer circumferential surface of the non-quenched portion in the reduced diameter portion and an end surface of the other high strength steel pipe may be welded to each other, and outer circumferential surfaces of the plurality of high strength steel pipes may be substantially coincident with each other.

[9] In the structural member according to any one of [1] to [8], a strength of the quenched portion in the high strength steel pipe may be 1,470 MPa or more.

[10] In the structural member according to any one of [1] to [9], a length of the structural member in a longitudinal direction may be more than 3,000 mm.

[11] In the structural member according to any one of [1] to [10], welded heat-affected zones may be separated from each other.

According to the present invention, it is possible to provide a structural member having high load-bearing performance and excellent impact energy absorption properties even in a case where a plurality of materials are connected by welding.

### BRIEF DESCRIPTION OF THE DRAWINGS

FIG. 1 is a front view showing a structural member according to a first embodiment of the present invention.

FIG. 2 is a front view showing a modification example of the structural member according to the embodiment.

FIG. 3 is a cross-sectional view showing another modification example of the structural member according to the embodiment.

FIG. 4 is a schematic view for describing a structural member according to a second embodiment of the present invention.

FIG. 5 is a perspective view of a joint part in a structural member according to a third embodiment of the present invention.

FIG. 6 is a schematic view showing the structural member according to the embodiment.

FIG. 7 is a partial cross-sectional view showing the structural member according to the embodiment.

FIG. 8 is a schematic view of a three-point bending analysis model.

FIG. 9 is a stress-strain curve of each portion of a structural member applied to a three-point bending analysis.

FIG. 10 is a graph showing a relationship between a punch displacement and a punch load for each of structural members having different lengths LA in a non-quenched portion.

FIG. 11 is a graph showing a relationship between the length LA of the non-quenched portion of a high strength steel pipe and a maximum load and an absorbed energy of the structural member.

FIG. 12 is a graph showing a relationship between a punch displacement and a punch load for each of structural members having different lengths LM in a center portion.

FIG. 13 is a graph showing a relationship between the length LM of the center portion of the joint part and the maximum load and the absorbed energy of the structural member.

FIG. 14 is a graph showing a relationship between a punch displacement and a punch load for each of structural members having different lengths LI in an end portion of the joint part.

FIG. 15 shows a relationship between the length LI of the end portion of the joint part and the maximum load and the absorbed energy of the structural member.

FIG. 16 is a graph showing a relationship between a punch displacement and a punch load for each of structural members having different wall thicknesses tJ in the joint part.

FIG. 17 is a graph showing a relationship between the wall thickness tJ of the joint part and the maximum load and the absorbed energy of the structural member.

FIG. 18 is a schematic view of a structural member for describing a modification example of the joint part in the third embodiment of the present invention.

FIG. 19 is a schematic view of a structural member for describing another modification example of the joint part in the third embodiment of the present invention.

FIG. 20 is a graph showing a relationship between a punch displacement and a punch load of Present Invention Example 1 and Comparative Example 1.

FIG. 21 is a graph comparing maximum loads of Present Invention Example 1 and Comparative Example 1.

FIG. 22 is a graph comparing absorbed energies of Present Invention Example 1 and Comparative Example 1.

FIG. 23 is a load-stroke diagram of structural members of Present Invention Examples 1 to 4 and Comparative Example 1.

FIG. 24 is a graph comparing maximum loads and amounts of absorbed energy of Present Invention Examples 1 to 4 and Comparative Example 1.

### EMBODIMENTS OF THE INVENTION

Hereinafter, a structural member according to an embodiment of the present invention will be described with reference to the accompanying drawings. Furthermore, dimensions and ratios of constituent elements in the drawings do not represent actual dimensions and ratios of the respective constituent elements. In addition, in the present specification and the drawings, a plurality of constituent elements having substantially the same constituent elements may be distinguished by adding different alphabets after the same reference numeral. In addition, there are cases where different aspects of structural members and constituent elements thereof are distinguished by adding different alphabets after the same reference numeral.

### First Embodiment

A structural member 1 according to the present embodiment includes a plurality of high strength steel pipes 10. First, the high strength steel pipe 10 used in the structural member 1 according to the present embodiment will be described. The high strength steel pipe 10 includes a quenched portion 130 at a pipe center portion and a non-quenched portion 140 extending over a whole circumference of at least one pipe end portion.

The quenched portion 130 is a portion in which an area ratio of a martensite is 90% or more. Since the martensite contributes to high-strengthening of the high strength steel pipe 10, the higher the area ratio is, the more preferable it is. The area ratio of the martensite of the quenched portion 130 is preferably 95% or more, and more preferably 98% or more.

The area ratio of the martensite is measured by the following method. That is, a target material is embedded in a resin or the like and cut to expose a cross section thereof, and the cross section is mirror-polished and then corroded in a 3% to 5% solution of nitric acid and ethanol for several seconds to several minutes. A sample thus obtained is observed with a metallurgical microscope, and the area ratio of each structure is calculated. Alternatively, the area ratio can also be calculated by image processing.

The quenched portion 130 is a portion having higher strength than the non-quenched portion 140. The strength of the quenched portion 130 is, for example, 1,470 MPa or more.

The strength of the quenched portion 130 is measured by the following method. That is, the strength can be measured by cutting out a tensile test piece (for example, a JIS No. 5 test piece) from the portion and conducting a tensile test. Alternatively, a method in which a Vickers hardness is measured and the value is converted into a tensile strength using the SAE J417 hardness conversion table may also be used.

The non-quenched portion 140 is a portion where an area ratio of a ferrite is 30% or more and 100% or less, an area ratio of a pearlite is 0% or more and 70% or less, and a total area ratio of a martensite and a bainite is 0% or more and 10% or less.

The area ratio of the ferrite of the non-quenched portion 140 is 30% or more and 100% or less. The non-quenched portion 140 is a portion that is not quenched or a portion that is quenched once and then annealed in the manufacturing of the high strength steel pipe 10. The area ratio of the ferrite of the non-quenched portion 140 depends on manufacturing conditions of the high strength steel pipe 10, but is usually 30% or more and 100% or less. The area ratio of the ferrite is preferably 50% or more, and more preferably 70% or more from the viewpoint of suppressing heat input softening and suppressing strength unevenness.

The area ratio of the pearlite of the non-quenched portion 140 is 0% or more and 70% or less. The area ratio of the pearlite of the non-quenched portion 140 depends on the manufacturing conditions of the high strength steel pipe 10, but is usually 0% or more and 70% or less. The area ratio of the pearlite is preferably 50% or less, and more preferably 30% or less from the viewpoint of suppressing a decrease in toughness due to transformation.

The total area ratio of the martensite and the bainite of the non-quenched portion 140 is 0% or more and 10% or less. The total area ratio of the martensite and the bainite of the non-quenched portion 140 depends on the manufacturing conditions of the high strength steel pipe 10, but is usually 0% or more and 10% or less. The martensite and the bainite are structures in which heat input softening is likely to occur, and thus amounts thereof are preferably small. The total area ratio of the martensite and the bainite is preferably 5% or less, and more preferably 3% or less.

The area ratio of the ferrite, the area ratio of the pearlite, and the total area ratio of the martensite and the bainite are measured by the following methods. That is, a target material is embedded in a resin or the like, cut to expose a cross section thereof, mirror-polished, and then corroded in a 3% to 5% solution of nitric acid and ethanol for several seconds to several minutes. A sample thus obtained is observed with a metallurgical microscope, and the area ratio of each structure is calculated. Alternatively, the area ratio can also be calculated by image processing.

The non-quenched portion 140 is a portion having lower strength than the quenched portion 130. The strength of the non-quenched portion 140 is preferably 690 MPa or less. Although the details will be described later, the non-quenched portion 140 is welded to another member. In general, when a portion having high strength is welded, a heat input portion is softened (heat input softening) by heat introduced during welding, and as a result, load-bearing performance and impact energy absorption properties of the structural member 1 decrease. However, when the strength of the non-quenched portion 140 into which welding heat is introduced is 690 MPa or less, heat input softening is prevented, and as a result, the decrease in the load-bearing performance and the impact energy absorption properties is suppressed. Therefore, the strength of the non-quenched portion 140 is preferably 690 MPa or less. The strength of the non-quenched portion 140 is more preferably 590 MPa or less. On the other hand, when the strength of the non-quenched portion 140 is too low, the non-quenched portion 140 tends to act as an origin of fracture under a low load. Therefore, the strength of the non-quenched portion 140 is preferably 440 MPa or more, and more preferably 490 MPa or more.

A welded heat-affected zone (HAZ portion, not shown) is generated in the vicinity of a welded position in the non-quenched portion 140. However, the HAZ portion of the non-quenched portion 140 is less likely to be affected by a difference in heat input conditions, and unevenness in size and hardness of the HAZ portions is small. Therefore, it is easy to predict physical properties such as the hardness of the HAZ portion, and it is possible to obtain the structural member 1 that is less affected by the HAZ portion.

The strength of the non-quenched portion 140 is measured by the following method. That is, the strength can be measured by cutting out a tensile test piece (for example, a JIS No. 5 test piece) from the non-quenched portion 140 and conducting a tensile test using the tensile test piece. Alternatively, a method in which a Vickers hardness is measured and the value is converted into a tensile strength using the SAE J417 hardness conversion table may also be used.

The quenched portion 130 is disposed in a pipe center portion 110 of the high strength steel pipe 10, and the non-quenched portion 140 is disposed over a whole circumference of the pipe end portion 120 of the high strength steel pipe 10.

The non-quenched portion 140 is preferably disposed in a portion from each pipe end portion 120 of the high strength steel pipe 10 to 10% or less of an axial length of the high strength steel pipe 10. In other words, a length of the non-quenched portion 140 is 10% or less of the length of the high strength steel pipe 10, and is preferably disposed at each pipe end portion 120. When the non-quenched portion 140 is too long, a ratio of the non-quenched portion 140 to a total length of the high strength steel pipe 10 is high, and a ratio of a low strength portion is high. Therefore, there are cases where the load-bearing performance of the high strength steel pipe 10 decreases. Therefore, the length of the non-quenched portion 140 is preferably 5% or less of the length of the high strength steel pipe 10. The length of the non-quenched portion 140 is more preferably 3% or less of the length of the high strength steel pipe 10.

On the other hand, the length of the non-quenched portion 140 may be such that welding can be performed in the portion and welding heat does not diffuse to the quenched portion 130, and may be, for example, 5 mm or more or 10 mm or more.

The length of the high strength steel pipe 10 is, for example, 2,000 mm or less. Usually, an upper limit of the length of the high strength steel pipe 10 that can be manufactured with existing facilities is 2,000 mm. Therefore, the length of the high strength steel pipe 10 is, for example, 2,000 mm or less. On the other hand, the length of the high strength steel pipe 10 can be, for example, 1,000 mm or more. However, when the length of the high strength steel pipe 10 is too short, in a case where a plurality of high strength steel pipes 10 are connected by welding to form a long structural member 1, the number of non-quenched portions 140 increases, and there is a possibility that fracture from the non-quenched portions 140 easily occurs. Therefore, the length of the high strength steel pipe 10 is preferably set to a length that allows the number of divisions to be reduced as much as possible. For example, in a case where the length of the structural member 1 is 3,000 mm, the length of the high strength steel pipe 10 is 1,500 mm, which is half of the length of the structural member 1. In a case where it is desired that a connection portion thereof is not located at a center in a longitudinal direction of the structural member due to an application of the structural member, for example, the length of the high strength steel pipe 10 may be set to 1,800 mm and 1,200 mm.

The structural member 1 according to the present embodiment preferably has a length of more than 3,000 mm in the longitudinal direction. When the length of the structural member 1 in the longitudinal direction is more than 3,000 mm, the structural member 1 can be used as a structural material of a structural member, for example, a main pillar or a roof, for a large vehicle, for example, a bus. The length of the structural member 1 in the longitudinal direction is not particularly limited. However, since an upper limit of the length of the structural member in one piece that can be manufactured with ordinary existing facilities is about 2,000 mm, the length of the structural member 1 in the longitudinal direction may be 2,100 mm or more, which is longer than the upper limit.

The plurality of high strength steel pipes 10 may be high strength steel pipes 10 including a quenched portion 130 or a non-quenched portion 140 which are different from each other in strength. Such high strength steel pipes 10 may be high strength steel pipes 10 which are different from each other in chemical compositions or manufacturing conditions. Alternatively, the high strength steel pipe 10 may be plated. In a case where the high strength steel pipe 10 is a plated steel pipe, a zinc plating, an Al—Si plating, or the like can be used as a plating coating. However, in the case where the high strength steel pipe is heated within a very short time by high-frequency heating, there is a concern that the plating layer turns into a liquid phase and is washed away during water cooling. Therefore, to prevent this, it is desirable to perform a heat treatment in advance and generate a diffusion alloy layer between the plating layer and a base metal layer.

Hitherto, the high strength steel pipe 10 has been described.

Subsequently, a structural member 1 according to the present embodiment will be described. In the structural member 1 according to the present embodiment, the high strength steel pipe 10 is welded to another member in the non-quenched portion 140. A portion of the non-quenched portion 140 that is welded to the other member is referred to as a welded portion 170.

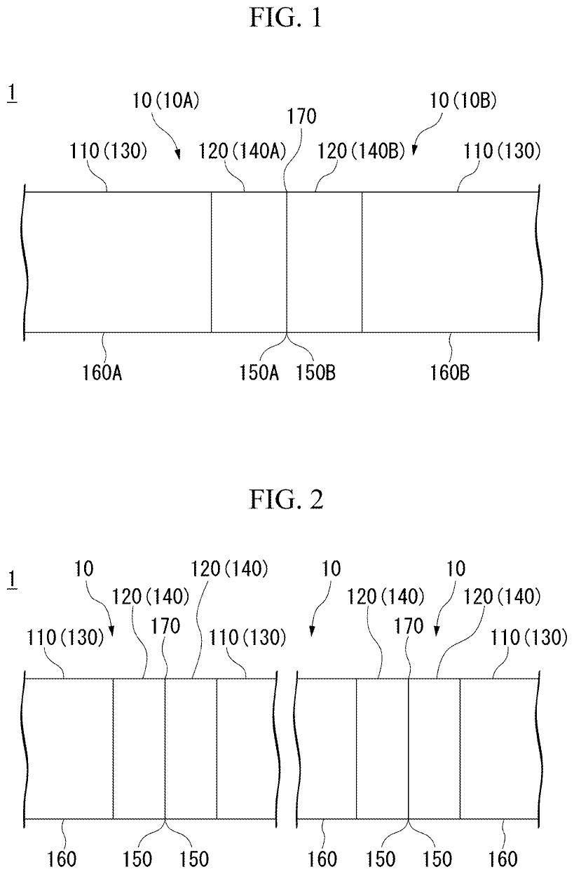

The structural member 1 according to the first embodiment of the present invention will be described with reference to FIG. 1. FIG. 1 is a front view showing the structural member 1 according to the first embodiment of the present invention. In the structural member 1 according to the present embodiment, an end surface 150A of a high strength steel pipe 10A and an end surface 150B of a high strength steel pipe 10B, which is another member, are welded to each other, and an outer circumferential surface 160A of the high strength steel pipe 10A and an outer circumferential surface 160B of the high strength steel pipe 10B are substantially coincident with each other (flush with each other). As shown in FIG. 1, the end surface 150A of the high strength steel pipe 10A and the end surface 150B of the high strength steel pipe 10B are respectively disposed in the non-quenched portions 140A and 140B, and the end surfaces 150A and 150B are the welded portions 170.

The high strength steel pipes 10A and 10B are welded to each other at the end surfaces 150A and 150B located in the non-quenched portion 140. Therefore, the heat input softening is suppressed. As a result, the strength of the structural member 1 in which the plurality of high strength steel pipes 10 are connected is secured. In addition, usually, in a structural member having unevenness, when the structural member and a member other than the structural member are attached during the manufacturing of a vehicle, it is necessary to align surfaces thereof. For example, it is necessary to fill gaps generated between a structural member having unevenness and other members with a packing or the like. On the other hand, in the structural member 1 according to the present embodiment, since the outer circumferential surface 160A of the high strength steel pipe 10A and the outer circumferential surface 160B of the high strength steel pipe 10B are formed to be substantially flush with each other, a gap is less likely to be formed between the structural member 1 and the other member, and the structural member 1 and the other member can be easily attached to each other during the manufacturing of a vehicle.

### Modification Example

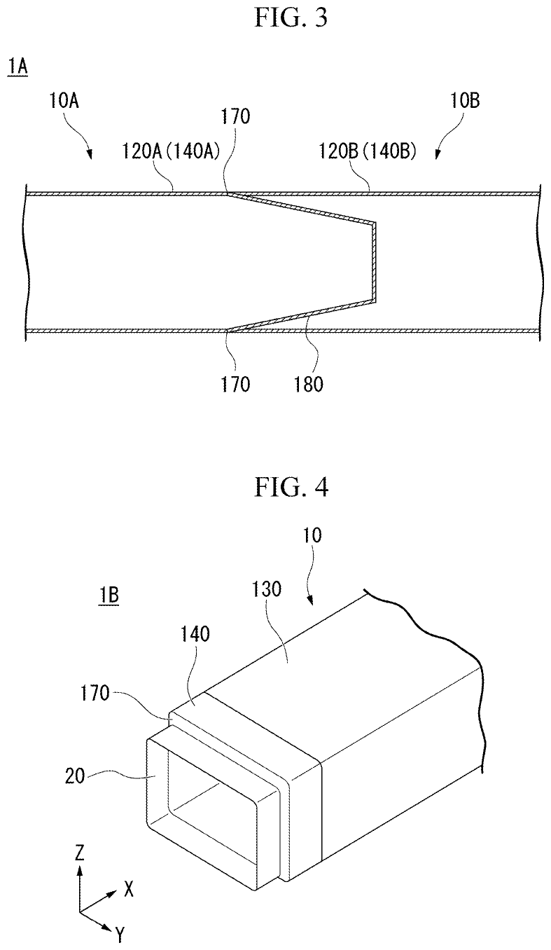

Subsequently, a modification example of the structural member 1 according to the first embodiment will be described with reference to FIGS. 2 and 3. FIGS. 2 and 3 are front views showing the modification example of the structural member 1 according to the present embodiment.

In the structural member 1 according to the first embodiment, at least two or more high strength steel pipes 10 are connected to each other. For example, the structural member 1 may have two high strength steel pipes 10 connected to each other as described above, or may have three or more high strength steel pipes 10 connected to each other as shown in FIG. 2.

Alternatively, in a structural member 1A according to the present modification example, as shown in FIG. 3, at least one high strength steel pipe 10A of a plurality of high strength steel pipes 10A and 10B may have a reduced diameter portion 180 which is smaller in diameter than a pipe center portion 110A in a pipe end portion 120A, the reduced diameter portion 180 may be inserted from a pipe end portion 120B of the high strength steel pipe 10B, and a non-quenched portion 140A and a non-quenched portion 140B in the other high strength steel pipe 10B may be welded to each other. Since the reduced diameter portion 180 is inserted from the pipe end portion 120B of the other high strength steel pipe 10B, strength of this insertion portion increases, and higher load-bearing performance and impact energy absorption properties can be obtained.

### Second Embodiment

Subsequently, a structural member 1B according to a second embodiment of the present invention will be described with reference to FIG. 4. FIG. 4 is a schematic view for describing the structural member 1B according to the second embodiment of the present invention. The structural member 1B according to the present embodiment includes the high strength steel pipe 10 and a joint part 20. The high strength steel pipe 10 is the same as the high strength steel pipe 10 according to the first embodiment. Therefore, a detailed description of the high strength steel pipe 10 will omitted.

As shown in FIG. 4, the joint part 20 has a tubular shape and has a cross section with substantially the same shape perpendicular to an axial direction (X direction) along the axial direction. The joint part 20 is inserted from each end portion 220 (not shown) of the joint part 20 into each of the adjacent high strength steel pipes 10. Respective end surfaces 150 of the adjacent high strength steel pipes 10 are separated from each other and are welded to the joint part 20 at different positions of the joint part 20 in the axial direction.

A length of the joint part 20 is not particularly limited and can be set to, for example, 50 mm or more. The joint part 20 can reinforce each non-quenched portion 140 having lower strength than the quenched portion 130 of the adjacent high strength steel pipes 10. Therefore, the length of the joint part 20 is preferably longer than a total length of the non-quenched portions 140 of the adjacent high strength steel pipes 10. An upper limit of the length of the joint part 20 is not particularly limited, but may be, for example, 80 mm or less or 100 mm or less from the viewpoint of a reduction in weight of the structural member 1B. The length of the joint part 20 mentioned here is a length between both ends in the axial direction.

A strength of the joint part 20 is preferably 590 MPa or less. When the strength of the joint part 20 is 590 MPa or less, the heat input softening is further prevented while suppressing a fracture of the structural member 1B originating from the joint part 20, so that the decrease in the load-bearing performance and the impact energy absorption properties is suppressed. Therefore, the strength of the joint part 20 is preferably 590 MPa or less. The strength of the joint part 20 may be 490 MPa or less. On the other hand, when the strength of the joint part 20 is too low, the joint part 20 tends to act as an origin of fracture. Therefore, the strength of the joint part 20 is preferably 390 MPa or more, and more preferably 440 MPa or more.

In the structural member 1B according to the second embodiment, the joint part 20 is inserted into the pipe end portions 120 of the adjacent high strength steel pipes 10 facing each other. In a state where the joint part 20 is inserted into each pipe end portion 120, the high strength steel pipes 10 are welded to the joint part 20 at different positions of the joint part 20 in the axial direction. At this time, the end surfaces 150 of the adjacent high strength steel pipes 10 are separated from each other.

When the welded portion 170 at which one high strength steel pipe 10 and the joint part 20 are welded to each other and the welded portion 170 at which the other high strength steel pipe 10 and the joint part 20 are welded to each other are too close to each other, there are cases where respective welded heat-affected zones (HAZ portions) generated in the welded portions 170 overlap. In this case, there are cases where the HAZ portions are connected to each other to generate one large HAZ portion, and a fracture originating from the HAZ portion is likely to occur, and there are cases where a portion where the HAZ portions overlap becomes significantly hard and tends to incur a fracture. Therefore, it is preferable that the HAZ portions are separated from each other. In order to separate the HAZ portions from each other, a distance between the two welded portions 170 may be increased. Although the distance between the two welded portions 170 depends on a degree of heat input during welding, for example, the distance between the two welded portions 170 may be set to 17 mm or more.

In the structural member 1B according to the second embodiment, the plurality of high strength steel pipes 10 are connected by at least one or more joint parts 20. For example, the structural member 1B may be a structural member in which two high strength steel pipes 10 are connected by one joint part 20, a structural member in which three high strength steel pipes 10 are connected in series by two joint parts 20, or a structural member in which four or more high strength steel pipes 10 are connected in series by three or more joint parts 20.

### Third Embodiment

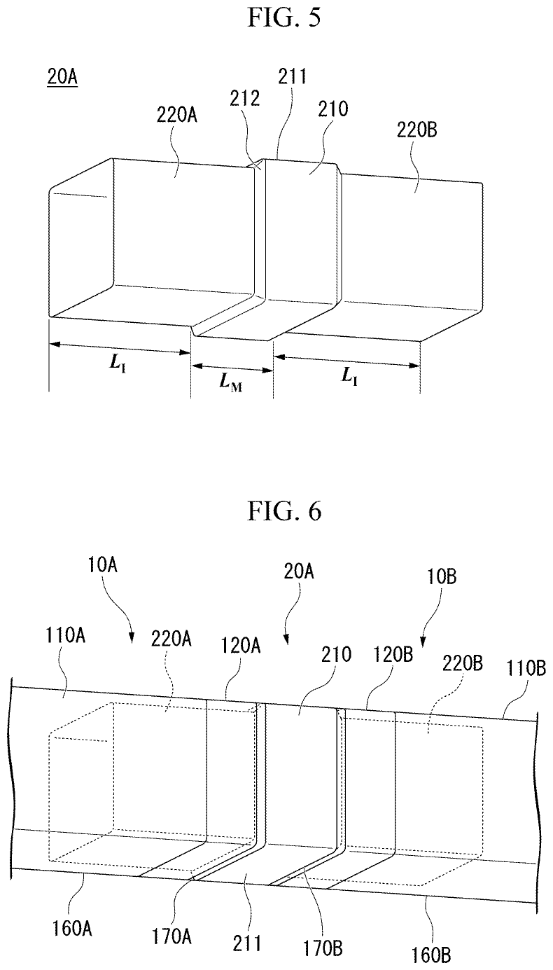

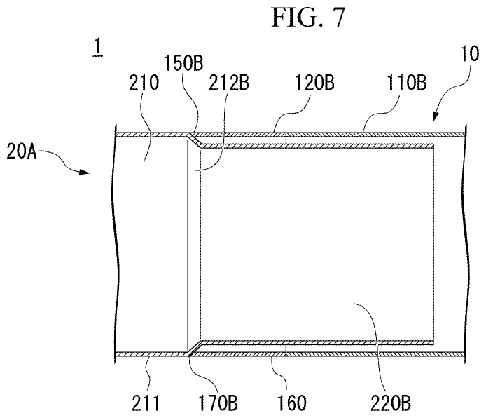

Subsequently, a structural member 1C according to a third embodiment of the present invention will be described with reference to FIGS. 5 to 7. FIG. 5 is a perspective view of a joint part 20A in the structural member 1C according to the third embodiment of the present invention. FIG. 6 is a schematic view showing the structural member 1C according to the present embodiment. FIG. 7 is a partial cross-sectional view showing the structural member 1C according to the present embodiment. The structural member 1C according to the present embodiment includes the high strength steel pipe 10 and the joint part 20A. In the structural member 1C according to the present embodiment, a shape of the joint part 20A is different from the shape of the joint part 20 in the second embodiment. Hereinafter, the shape of the joint part 20A will be described in detail. The high strength steel pipe 10 is the same as the high strength steel pipe 10 according to the first embodiment. Therefore, a detailed description of the high strength steel pipe 10 will omitted.

As shown in FIG. 5, the joint part 20A is hollow, has a center portion 210 having a diameter larger than the end portions 220 disposed at both ends of the joint part 20A in the axial direction, and an outer diameter of the end portion 220 is smaller than an inner diameter of the high strength steel pipe 10. The end portion 220 is connected to a connection portion 212 of the center portion 210.

A length of the joint part 20A in the axial direction is LM+2×LI, which is a sum of a length LM of the center portion 210 in the axial direction and lengths LI of the two end portions 220 in the axial direction.

The length LI of the end portion 220 of the joint part 20A is not particularly limited and can be set to, for example, 20 mm or more. From the viewpoint of reinforcing the non-quenched portion 140 of the high strength steel pipe 10, it is preferable that the length LI of the end portion 220 is larger than the length LA of the non-quenched portion 140 of the high strength steel pipe 10. An upper limit of the length LI of the end portion 220 of the joint part 20A is not particularly limited, but may be, for example, 50 mm or less, or 30 mm or less from the viewpoint of a reduction in weight of the structural member 1C.

A strength of the joint part 20A is preferably 590 MPa or less, similarly to the strength of the joint part 20 in the second embodiment. When the strength of the joint part 20A is 590 MPa or less, the formation of the joint part 20A by hydroforming or the like is facilitated in addition to the suppression of the above-described decrease in the load-bearing performance and the impact energy absorption properties. Therefore, the strength of the joint part 20A is preferably 590 MPa or less. The strength of the joint part 20A may be 490 MPa or less. On the other hand, when the strength of the joint part 20A is too low, the joint part 20A tends to act as an origin of fracture. Therefore, the strength of the joint part 20A is preferably 390 MPa or more, and more preferably 440 MPa or more.

In the structural member 1C according to the third embodiment, as shown in FIGS. 6 and 7, the outer diameter of the end portion 220 is smaller than the inner diameter of the high strength steel pipe 10, the end portions 220A and 220B are respectively inserted into pipe end portions 120A and 120B of the adjacent high strength steel pipe 10A and 10B facing each other, and an outer circumferential surface 211 of the center portion 210 and an outer circumferential surface 160 of the high strength steel pipe 10 are substantially flush with each other. In the structural member 1C according to the third embodiment, for example, as shown in FIG. 7, the end surface 150B of the high strength steel pipe 10 and the connection portion 212 are welded to each other to generate welded portions 170A and 170B. In order to allow the outer circumferential surface 160A of the high strength steel pipe 10A and the outer circumferential surface 160B of the high strength steel pipe 10B to be substantially flush with the outer circumferential surface 211 of the center portion 210 of the joint part 20A, it is preferable that the cross section of the high strength steel pipe 10 and the cross section of the center portion 210 in the joint part 20A have substantially the same shape. In FIGS. 5 to 7, the connection portion 212 between the end portions 220A and 220B and the center portion 210 in the joint part 20A has a tapered shape. However, the shape of the connection portion 212 is not limited to the tapered shape and may be a stepped shape.

Also in the present embodiment, as in the second embodiment, it is preferable that a plurality of the HAZ portions are separated from each other. In order for the plurality of HAZ portions to be separated from each other, the length LM of the center portion 210 in the joint part 20A may be increased. Although the length LM of the center portion 210 depends on the degree of heat input during welding, for example, the length LM of the center portion 210 may be set to 17 mm or more.

### (Length LA of Non-Quenched Portion 140 in High Strength Steel Pipe 10)

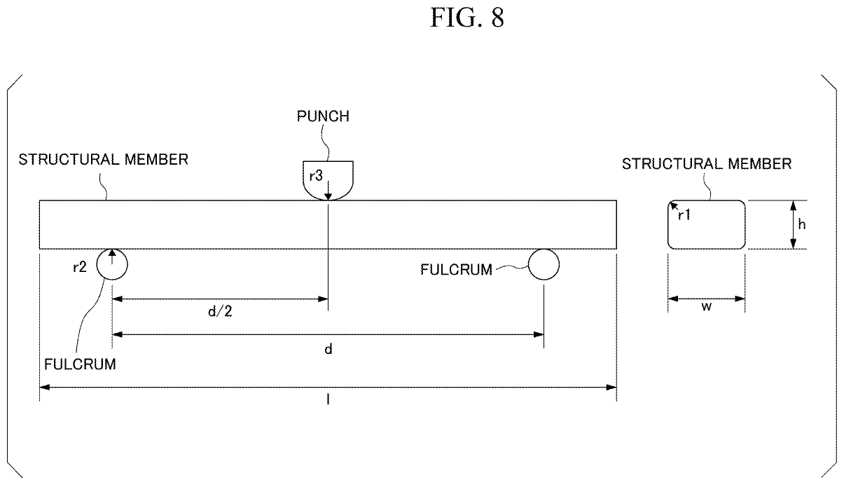

The present inventors considered that the length LA of the non-quenched portion 140 in the high strength steel pipe 10 affects the load-bearing properties and the impact energy absorption properties, and investigated a relationship between the load-bearing properties and the impact energy absorption properties and the length LA of the non-quenched portion 140 by conducting a three-point bending analysis using the finite element method (FEM). FIG. 8 shows a schematic view of a three-point bending analysis model.

In the three-point bending analysis model as shown in FIG. 8, assuming that cracking occurs when a wall thickness of the high strength steel pipe or a wall thickness of the joint part decreases by 20%, maximum loads and amounts of absorbed energy until cracking occurs or until a displacement (stroke) of a punch that applies a load to the structural member reaches 100 mm. A length (length in the axial direction) 1 of the structural member was set to 1,500 mm, a width (length in a horizontal direction) w of the structural member was set to 70 mm, and a height (length in a vertical direction, in other words, a load direction) h of the structural member was set to 50 mm. A wall thickness t of the structural member was set to 1.8 mm, and a radius of curvature r1 of a corner portion at an outer circumference of the structural member was set to 3.6 mm. A distance d between two fulcrums was set to 1,000 mm, and a radius of curvature r2 of a portion of each fulcrum in contact with the structural member was set to 12.5 mm. A radius of curvature r3 of a portion of the punch that applies a load to the structural member in contact with the structural member was set to 38 mm. At a midpoint between the two fulcrums, a load was applied to the structural member from above by the punch. A speed v of the punch relative to the structural member was set to 2 m/sec. As a solver, LS-DYNA was used, and 2 mm shell elements and a friction coefficient of 0.1 were set.

A wall thickness tJ of the joint part was set to 3.2 mm, the length LM of the center portion of the joint part was set to 34 mm, and the length LI of the end portion of the joint part was set to 50 mm. The length LI of the end portion of the joint part was assumed to be equal to an insertion length into the high strength steel pipe. The length LA of the non-quenched portion in the high strength steel pipe was set to 6 mm, 12 mm, 18 mm, 24 mm, and 30 mm.

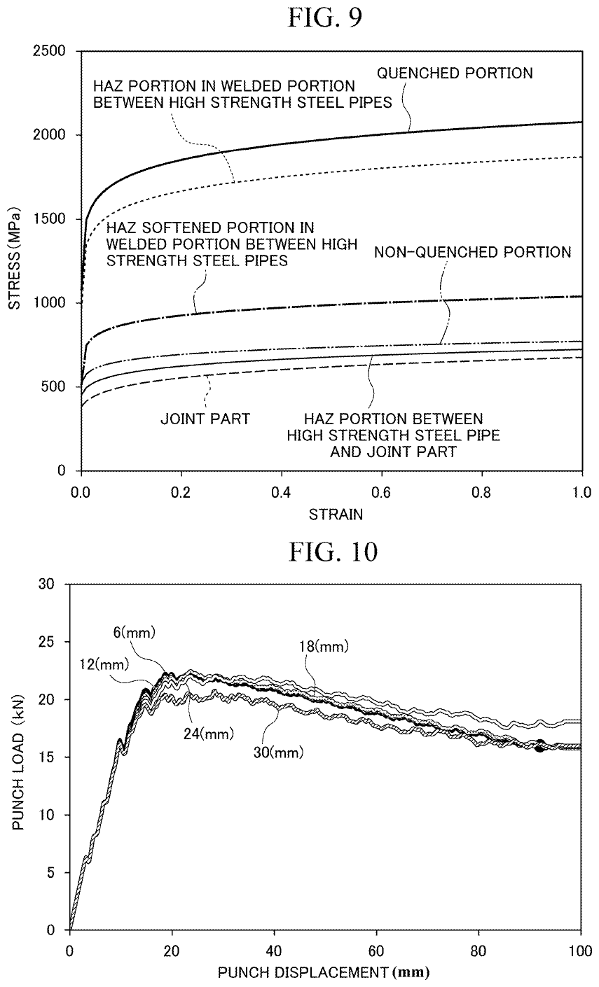

FIG. 9 shows a stress-strain curve of each portion of the structural member applied to the three-point bending analysis. Specifically, FIG. 9 shows stress-strain curves of the quenched portion and the non-quenched portion of the high strength steel pipe applied to the three-point bending analysis, the joint part, the HAZ portion in the welded portion when the high strength steel pipes are welded to each other, a HAZ softened portion of the HAZ portion in the welded portion when the high strength steel pipes are welded to each other, and HAZ in the welded portion when the high strength steel pipe and the joint part are welded to each other. The strength of the joint part was set to be in a 440 MPa-grade, and the strength of the quenched portion of the high strength steel pipe was set to be in a 1,470 MPa-grade. The strength of the non-quenched portion was set to be in a 590 MPa-grade. In the HAZ portion in the welded portion when the high strength steel pipes are welded to each other, it was assumed that the same amount of strain as that in the quenched portion was generated by a stress of 50% of the quenched portion. In the HAZ portion in the welded portion when the high strength steel pipe and the joint part are welded, it was assumed that the same amount of strain is generated by an average stress of a stress of the non-quenched portion and a stress of the joint part. In the HAZ softened portion in the welded portion between the high strength steel pipes, the stress-strain curve shown in FIG. 9 of the quenched portion was obtained by an experiment by the inventors.

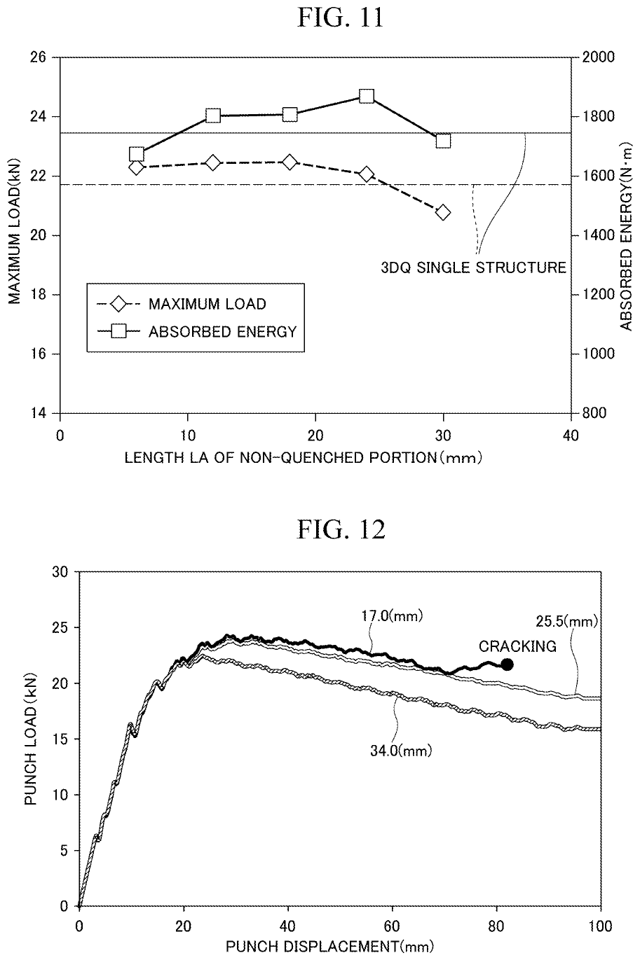

FIG. 10 shows a graph showing a relationship between a punch displacement and a punch load for each structural member in which the length of each non-quenched portion of each high strength steel pipe is LA, and FIG. 11 shows a graph showing a relationship between the length LA of the non-quenched portion of the high strength steel pipe, and the maximum load and absorbed energy of the structural member. In FIG. 11, for reference, a maximum load value and an amount of absorbed energy of a structural member in one piece without joining a plurality of high strength steel pipes are indicated by “3DQ single structure”. As shown in FIG. 11, it was found that when the length LA of the non-quenched portion is 6 to 30 mm, the maximum load is 20 kN or more, and the amount of absorbed energy is 1,600 N·m or more. Therefore, it was found that the length LA of the non-quenched portion 140 in the high strength steel pipe 10 is preferably 6 to 30 mm. It was found that when the length LA of the non-quenched portion in the high strength steel pipe is too long, buckling occurs in the non-quenched portion on an inside of a bend. However, it was found that since strain is less likely to concentrate on an outside of the bend in the non-quenched portion, cracking does not occur. Contrary to this, it was found that when the length LA of the non-quenched portion in the high strength steel pipe is too short, while buckling is less likely to occur in the non-quenched portion, the load applied to the joint part increases, and buckling occurs in the joint part.

### (Length LM of Center Portion 210 in Joint Part 20A)

The present inventors investigated a relationship between the load-bearing properties and the impact energy absorption properties and the length LM of the center portion 210 in the joint part 20A by conducting a three-point bending analysis using the FEM. The wall thickness tJ of the joint part was set to 3.2 mm, the length LA of the non-quenched portion in the high strength steel pipe was set to 18 mm, and the length LI of the end portion of the joint part was set to 50 mm. The length LM of the center portion in the joint part was set to 17.0 mm, 25.5 mm, and 34.0 mm. Other conditions were the same as above.

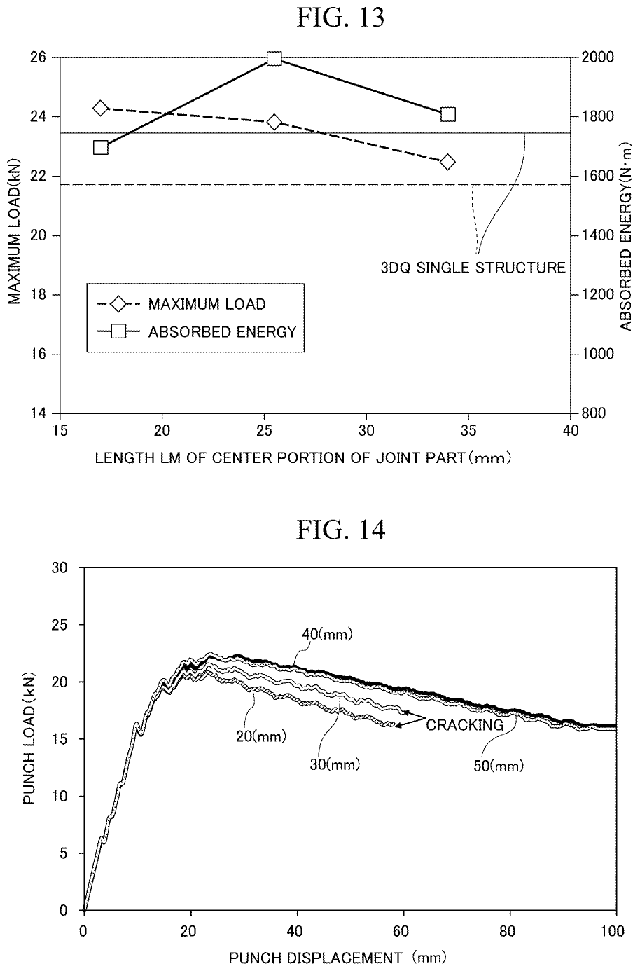

FIG. 12 shows a graph showing a relationship between a punch displacement and a punch load for each structural member having the length LM in each center portion, and FIG. 13 shows a graph showing a relationship between the length LM of the center portion of the joint part, and the maximum load and absorbed energy of the structural member. In FIG. 13, for reference, the maximum load value and the amount of absorbed energy of the structural member in one piece without joining a plurality of high strength steel pipes are indicated by “3DQ single structure”. As shown in FIG. 13, it was found that when the length LM of the center portion is 17.0 to 34.0 mm, the maximum load is 20 kN or more, and the amount of absorbed energy is 1,600 N·m or more. Therefore, it was found that the length LM of the center portion 210 in the joint part 20A is preferably set to 17.0 to 34.0 mm. In addition, it was found that when the length LM of the center portion of the joint part becomes long, buckling easily occurs in the joint part. On the other hand, it was found that when the length LM of the center portion of the joint part becomes short, while buckling in the joint part is suppressed, the load applied to the non-quenched portion of the high strength steel pipe is increased by that amount, and buckling on the inside of the bend and cracking on the outside are likely to occur. In addition, it was found that, as a modification mode, while it is desirable that buckling occurs in the joint part, when the length LM of the center portion in the joint part is too long, the maximum load and the absorbed energy tend to decrease.

### (Length LI of End Portion 220 of Joint Part 20A)

The present inventors investigated a relationship between the load-bearing properties and the impact energy absorption properties and the length LI of the end portion 220 of the joint part 20A by conducting a three-point bending analysis using the FEM. The wall thickness tJ of the joint part was set to 3.2 mm, the length LA of the non-quenched portion in the high strength steel pipe was set to 18 mm, and the length LM of the center portion in the joint part was set to 34 mm. The length LI of the end portion of the joint part was set to 20 mm, 30 mm, 40 mm, and 50 mm. Other conditions were the same as above.

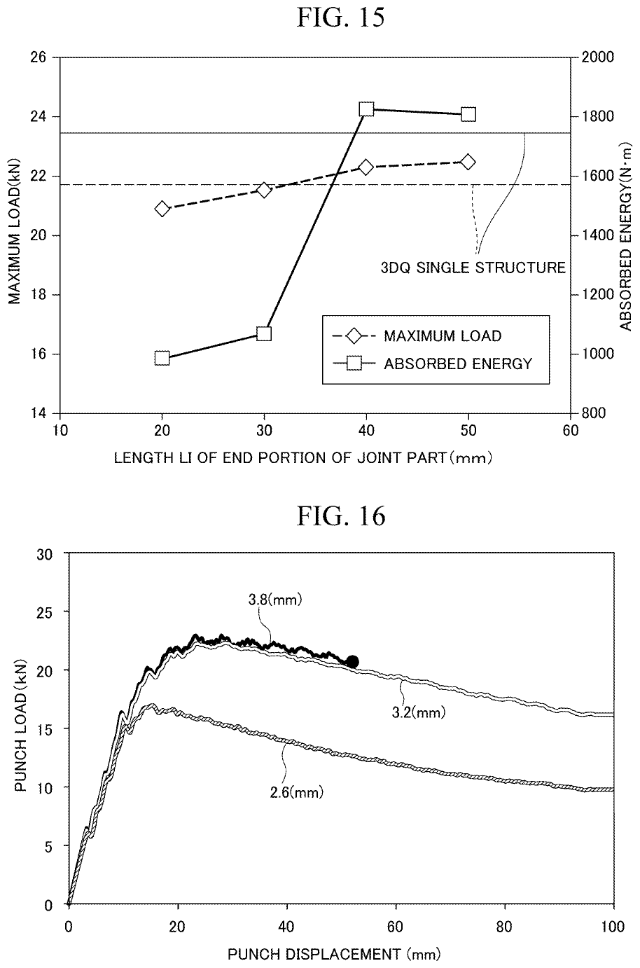

FIG. 14 shows a graph showing a relationship between a punch displacement and a punch load for each structural member having the length LI in each end portion, and FIG. 15 shows a graph showing a relationship between the length LI of the end portion of the joint part, and the maximum load and absorbed energy of the structural member. In FIG. 15, for reference, the maximum load value and the amount of absorbed energy of the structural member in one piece without joining a plurality of high strength steel pipes are indicated by “3DQ single structure”. As shown in FIG. 14, cracking had occurred when the length LI of the end portion of the joint part was 30 mm or less. However, as shown in FIG. 15, it was found that even in a case where cracking occurs, the maximum load is 20 kN or more, and the amount of absorbed energy is as large as about 1,000 N·m or more. In addition, it was found that, when the length LI of the end portion 220 is 40 mm or 50 mm, the maximum load is 20 kN or more, and the amount of absorbed energy is about 1,000 N·m or more. Therefore, it was found that the length LM of the center portion 210 in a joint part 20C is preferably set to 20 to 50 mm. It was found that when the length LI of the end portion of the joint part is too long, the joint part tends to follow the deformation of the high strength steel pipe and buckling occurs in the center portion. Contrary to this, when the length LI of the end portion of the joint part is too short, the joint part is less likely to deform, strain concentrates on the high strength steel pipe by that amount, buckling on the inside of the bend and cracking on the outside are likely to occur, and the maximum load and the absorbed energy tend to decrease.

### (Wall Thickness tJ of Joint Part 20C)

The present inventors investigated a relationship between the load-bearing properties and the impact energy absorption properties and the wall thickness tJ of the joint part 20C of 3.2 mm by conducting a three-point bending analysis using the FEM. The length LI of the end portion of the joint part was set to 40 mm, the length LA of the non-quenched portion in the high strength steel pipe was set to 18 mm, and the length LM of the center portion in the joint part was set to 34 mm. The length LI of the end portion of the joint part was set to 2.6 mm, 3.2 mm, and 3.8 mm. Other conditions were the same as above.

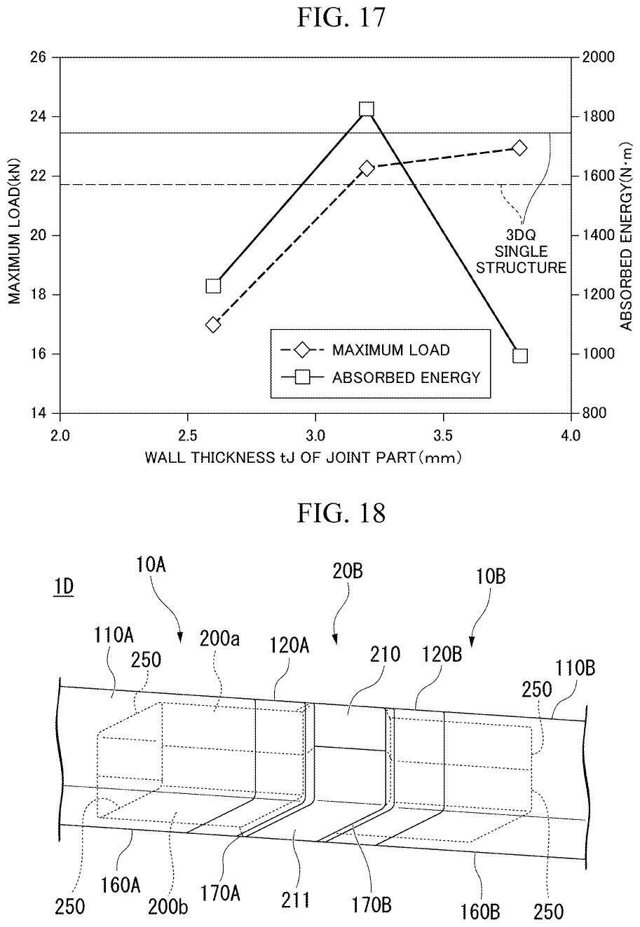

FIG. 16 shows a graph showing a relationship between a punch displacement and a punch load for each structural member having the wall thickness tJ in each joint part, and FIG. 17 shows a graph showing a relationship between the wall thickness tJ of the joint part, and the maximum load and absorbed energy of the structural member. In FIG. 17, for reference, the maximum load value and the amount of absorbed energy of the structural member in one piece without joining a plurality of high strength steel pipes are indicated by “3DQ single structure”. As shown in FIG. 16, cracking had occurred when the wall thickness tJ of the joint part was 3.8 mm. However, as shown in FIG. 17, it was found that even in a case where cracking occurs, the maximum load is 22 kN or more, and the amount of absorbed energy is as large as about 1,000 N·m. In addition, it was found that, when the wall thickness tJ of the joint part is 2.6 mm, the maximum load is about 16 kN, and the amount of absorbed energy is about 1,200 N·m. Therefore, it was found that the wall thickness tJ of the joint part 20 can be set to 2.6 to 3.8 mm. As can be seen from FIGS. 16 and 17, it was found that when the wall thickness tJ of the joint part is too thick, the joint part is less likely to deform, so that the load applied to the non-quenched portion increases, and buckling on the inside of the bend and cracking on the outside of the bend are likely to occur. On the other hand, it was found that when the wall thickness tJ of the joint part is too small, a buckling mode is a mode in which the joint part buckles, while the maximum load and the absorbed energy are greatly affected by a joint sheet thickness and these values thus tend to significantly decrease.

In the structural member 1C according to the third embodiment, similarly to the structural member 1B according to the second embodiment, the high strength steel pipes 10 can be connected in series by at least one or more joint parts 20A.

Hitherto, the structural member 1C according to the third embodiment has been described.

### Modification Example

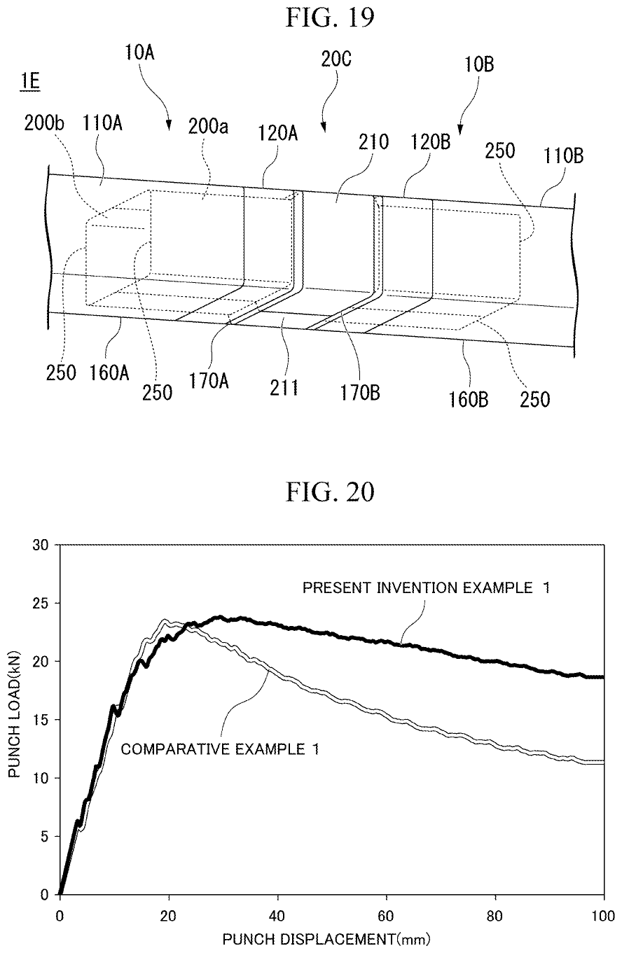

Subsequently, a modification example of the joint part 20A in the third embodiment will be described with reference to FIGS. 18 and 19. FIG. 18 is a schematic view of a structural member 1D for describing the modification example of the joint part 20A in the third embodiment of the present invention, and FIG. 19 is a schematic view of a structural member 1E for describing another modification example of the joint part 20A in the third embodiment of the present invention.

The structural members 1D and 1E include joint parts 20B and 20C each constituted by two parts 200a and 200b. Each of the parts 200a and 200b constituting the joint parts 20B and 20C includes a portion included in an end surface 250 of the joint parts 20B and 20C as shown in FIGS. 18 and 19. In other words, the parts 200a and 200b constituting the joint parts 20B and 20C are members extending in the axial direction of the high strength steel pipe 10. Each of the structural members 1D and 1E shown in FIGS. 18 and 19 has a rectangular cross section perpendicular to a pipe axis. FIG. 18 shows the joint part 20B in which the two parts 200a and 200b are butted against to each other to form a surface to which a short side of the cross section belongs, and FIG. 19 shows the joint part 20C in which the two parts 200a and 200b are butted against to each other to form a surface to which a long side of the cross section belongs. As described above, each of the joint parts 20B and 20C in the structural members 1D and 1E is constituted by the two parts 200a and 200b, and each of the two parts 200a and 200b includes a portion included in the end surface 250 of the joint part. Each of the joint parts 20B and 20C may be constituted by three or more parts.

In the structural member 1D including the joint part 20B constituted by a plurality of the parts 200a and 200b and the structural member 1E including the joint part 20C constituted by a plurality of the parts 200a and 200b, as will be described later, while fracture occurs under a low load and the amount of absorbed impact energy decreases compared to the structural member 1C including the joint part 20A configured in one piece, a high load capacity and a high amount of absorbed impact energy are secured in an initial stage of deformation. In a vehicle in which the structural member 1D including the joint part 20B or the structural member 1E including the joint part 20C is used, a space inside the vehicle is secured even in the event of an external impact, so that safety is maintained. In addition, for example, in a case of forming the joint part 20A having the center portion 210 with an enlarged diameter as shown in FIG. 5 in one piece, there is a concern that hydroforming or multi-process pressing is required, which increases costs. However, in a case where the joint parts 20B and 20C are formed of a plurality of the parts 200a and 200b as shown in FIGS. 18 and 19, it is not necessary to perform hydroforming or multi-process pressing, and an increase in manufacturing cost can be suppressed.

Hitherto, the examples of the structural member according to the present invention have been described while showing a plurality of embodiments. As shown in the first to third embodiments, the structural members 1 to 1E include a plurality of the high strength steel pipes 10 in which the non-quenched portion 140 having lower strength than the quenched portion 130 of the pipe center portion 110 is disposed in the pipe end portion 120, and the plurality of high strength steel pipes 10 are welded to other members at the non-quenched portion 140. By welding the non-quenched portions 140, heat input softening is suppressed. Accordingly, even in the structural members 1 to 1E in which the plurality of high strength steel pipes 10 are connected, the strength thereof can be secured. As a result, the structural member 1 can obtain high load-bearing performance and excellent impact energy absorption properties.

A manufacturing method of the high strength steel pipe 10 is not particularly limited. For example, a three-dimensional hot bending and quenching technique may be applied in which local heating and bending are performed, followed immediately by water cooling for quenching.

In addition, the welding of the high strength steel pipes 10 and the welding of the high strength steel pipes 10 and the joint parts 20A to 20C may be performed by a welding method such as arc welding, MAG welding, MIG welding, or TIG welding.

While the preferred embodiments of the present invention have been described above in detail with reference to the drawings, the present invention is not limited to such examples.

It is obvious that a person having ordinary knowledge in the technical field to which the present invention pertains can come up with various changes or modifications within the scope of the technical idea described in the claims, and it is understood that these also belong to the technical scope of the present invention.

For example, the above-described joint part is a hollow tubular member configured in a linear shape. However, the joint part is not limited to a linear shape as long as the joint part is a hollow tubular member. For example, the joint part may be a hollow tubular member configured in a branched shape such as a T-shape or a Y-shape, or a hollow tubular member having a curved portion such as a U-shape.

A cross-sectional shape of the high strength steel pipe is not limited to a rectangular shape and may be various shapes such as a polygonal shape including a square shape, a circular shape, and an elliptical shape.

In addition, in the above description, as the modification example of the joint part of the third embodiment, as shown in FIGS. 18 and 19, the joint parts 20B and 20C in which the two parts 200a and 200b are butted against each other and the center portion 210 is provided have been described. However, the two parts constituting the joint part may not have a center portion with an enlarged diameter. For example, the two parts constituting the joint part may have a constant cross-sectional shape in the axial direction. A joint part in which the two parts are butted against each other does not have a portion having an enlarged diameter.

In addition, the above-described modification examples and embodiments may be combined to the extent possible.

### EXAMPLES

Next, examples of the present invention will be shown, but conditions in the examples are one example of conditions adopted to confirm the feasibility and effect of the present invention, and the present invention is not limited to the conditions used in the following examples. The present invention may adopt various conditions to achieve the object of the present invention without departing from the scope of the present invention.

### Example 1

From FIGS. 10 to 17, an FEM analysis was performed so that excellent load-bearing properties and impact energy absorption properties are achieved by setting the length LA of the non-quenched portion in the high strength steel pipe to 18 mm, the length LM of the center portion in the joint part to 25 mm, the length LI of the end portion of the joint part to 50 mm, and the wall thickness tJ of the joint part to 3.2 mm (Present Invention Example 1). Analysis conditions were the same as described above. In addition, in order to confirm the effect of the conditions, the analysis was also performed on a high strength steel pipe single structure (Comparative Example 1).

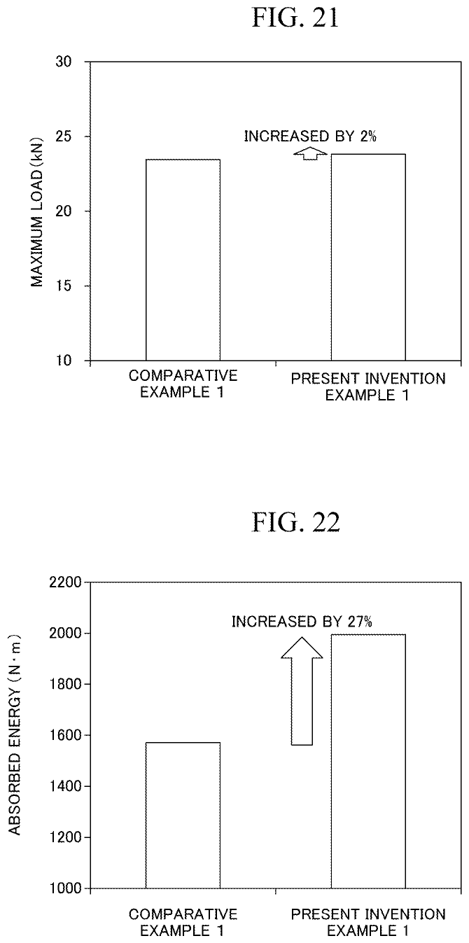

Analysis results are shown in FIGS. 20 to 22. FIG. 20 is a graph showing a relationship between the punch displacement and the punch load of Present Invention Example 1 and Comparative Example 1, FIG. 21 is a graph comparing the maximum loads of Present Invention Example 1 and Comparative Example 1, and FIG. 22 is a graph comparing the amounts of absorbed energy of Present Invention Example 1 and Comparative Example 1. As shown in FIG. 21, in Present Invention Example 1, the maximum load was increased by 2% compared to Comparative Example 1, and as shown in FIG. 22, in Present Invention Example 1, the absorbed energy was increased by 27% compared to Comparative Example 1.

It was found that a weight of the structural member of Present Invention Example 1 is increased by 7% compared to the structural member of Comparative Example 1. However, it was found that a wall thickness of 3.2 mm or more is required to obtain the same performance as that of Present Invention Example 1 with a 590 MPa-grade steel material. It was found that in Present Invention Example 1, a significant decrease in weight is possible compared to the high strength steel pipe single structure having a wall thickness of 3.2 mm or more.

### Example 2

In a case where a joint part having an enlarged diameter at a center portion is formed in one piece, there is a concern that hydroforming or multi-process pressing is required, which increases costs. However, in a case where a joint part is formed of a plurality of parts, which are parts extending in the axial direction of the high strength steel pipe, an increase in manufacturing cost can be suppressed. The present inventors investigated the load-bearing properties and the impact energy absorption properties of the joint part of the modification example by conducting a three-point bending analysis using the FEM. Models of the structural member to be analyzed include the structural member shown in FIG. 4 (Present Invention Example 2), the structural member shown in FIG. 19 (Present Invention Example 3), the structural member shown in FIG. 19 (Present Invention Example 4), the structural member of Present Invention Example 1, and the structural member of Comparative Example 1. It is assumed that in the structural member shown in FIG. 4, the joint part without a center portion having an enlarged diameter, which is an angular tubular joint part, is used, and the end surfaces of the adjacent high strength steel pipes are welded to each other. In the structural member shown in FIG. 19 and the structural member shown in FIG. 18, the members constituting the structural member are not welded to each other and face each other with a gap of 1 mm therebetween. Other conditions were the same as those described above.

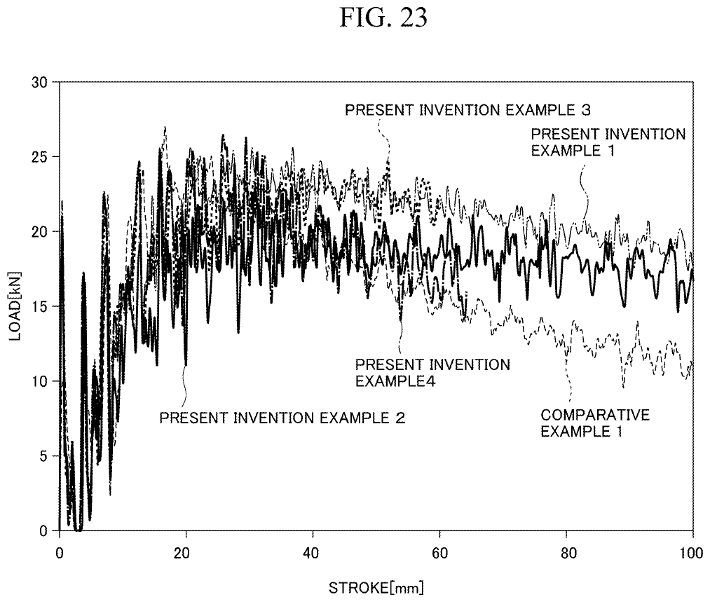

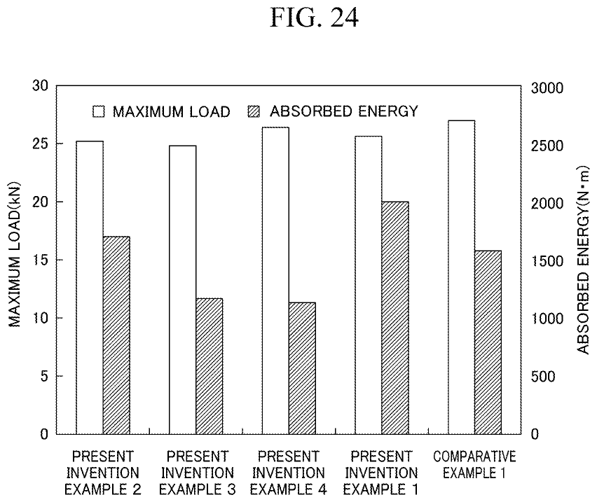

Analysis results are shown in FIGS. 23 and 24. FIG. 23 is a load-stroke diagram of the structural members of Present Invention Examples 1 to 4 and Comparative Example 1, and FIG. 24 is a graph comparing the maximum loads and the amounts of absorbed energy of Present Invention Examples 1 to 4 and Comparative Example 1. Regarding the maximum load, it was found that, in any of the structural members of Present Invention Examples 1 to 4, a maximum load of the same degree as that of Comparative Example 1 can be obtained. Regarding the amount of absorbed energy, it was found that the structural member of Present Invention Example 1 can obtain a larger amount of absorbed energy than the structural member of Comparative Example 1. It was found that the structural member of Present Invention Example 2 can obtain a significantly larger amount of absorbed energy than the structural member of Comparative Example 1. On the other hand, it was found that in Present Invention Examples 3 and 4, the joint part cannot follow the deformation in the middle of the load being applied, cracking occurs at a stroke of about 60 mm, and the absorbed energy decreases. However, the performance required in an actual vehicle structure is not pure three-point bending, and the required performance is the securing of a survival space. Therefore, it was found that Present Invention Examples 3 and 4, in which a high load and a large amount of absorbed energy can be obtained from the initial stage of deformation, are also examples applicable to the vehicle from the viewpoint of collision safety.

### BRIEF DESCRIPTION OF THE REFERENCE SYMBOLS

1, 1A, 1B, 1C, 1D, 1E Structural member
10, 10A, 10B, 10C High strength steel pipe
20, 20A, 20B, 20C Joint part
110 Pipe center portion
120, 120A, 120B Pipe end portion
130 Quenched portion
140, 140A, 140B Non-quenched portion
150 End surface of high strength steel pipe
160 Outer circumferential surface
170 Welded portion
180 Reduced diameter portion
210 Center portion
211 Outer circumferential surface
212 Connection portion
220 End portion
250 End surface of joint part

What is claimed is:

1. A structural member comprising:
a plurality of high strength steel pipes,
wherein the high strength steel pipe has a quenched portion in a pipe center portion and a non-quenched portion extending over a whole circumference of at least one pipe end portion,
in the quenched portion, an area ratio of a martensite is 90% or more,
in the non-quenched portion,
an area ratio of a ferrite is 30% or more and 100% or less,
an area ratio of a pearlite is 0% or more and 70% or less, and
a total area ratio of a martensite and a bainite is 0% or more and 10% or less, and
the non-quenched portion has a welded portion that is welded to another member.

2. The structural member according to claim 1, further comprising:
as the other member, a joint part that is a hollow tubular member and has a center portion having a diameter larger than both end portions, and connection portions that connect both the end portions and the center portion,
wherein an end surface of the high strength steel pipe disposed in the non-quenched portion and the connection portion in the joint part are welded to each other, and
an outer circumferential surface of the high strength steel pipe and an outer circumferential surface of the center portion are substantially coincident with each other.

3. The structural member according to claim 2,
wherein the joint part is configured in a linear shape.

4. The structural member according to claim 1, further comprising:
as the other member, a joint part that is a hollow tubular member configured in a linear shape and has substantially the same diameter along an axial direction,
wherein end portions of the joint part in the axial direction are respectively inserted into the high strength steel pipes adjacent to each other, and
respective end portions of the high strength steel pipes adjacent to each other are separated from each other and are welded to the joint part at different positions of the joint part in the axial direction.

5. The structural member according to any one of claims 2 to 4,
the joint part is constituted by two or more parts, and
each of the two or more parts includes a portion included in an end surface of the joint part.

6. The structural member according to any one of claims 2 to 5,
wherein a strength of the joint part is 590 MPa or less.

7. The structural member according to claim 1,
wherein an end surface of the high strength steel pipe disposed in the non-quenched portion and an end surface of the high strength steel pipe disposed in the non-quenched portion, which is the other member, are butt-welded to each other such that outer circumferential surfaces of the high strength steel pipes are substantially coincident with each other.

8. The structural member according to claim 1,
wherein at least one high strength steel pipe among the plurality of high strength steel pipes has a reduced diameter portion which is smaller in diameter than the pipe center portion in a predetermined region from an end surface of the high strength steel pipe toward a center in the axial direction,
the reduced diameter portion is inserted into the other high strength steel pipe, which is the other member,
an outer circumferential surface of the non-quenched portion in the reduced diameter portion and an end surface of the other high strength steel pipe are welded to each other, and
outer circumferential surfaces of the plurality of high strength steel pipes are substantially coincident with each other.

9. The structural member according to any one of claims 1 to 8,
wherein a strength of the quenched portion in the high strength steel pipe is 1,470 MPa or more.

10. The structural member according to any one of claims 1 to 9,
wherein a length of the structural member in a longitudinal direction is more than 3,000 mm.

11. The structural member according to any one of claims 1 to 10,
wherein welded heat-affected zones are separated from each other.
